(19) United States
(12) Patent Application Publication
(10) Pub. No.: US 2007/0220905 A1
(43) Pub. Date: Sep. 27, 2007

(54) Cooling Water for a Natural Gas Conversion Complex

(76) Inventors: Desmond Johan Clur, Mosselbay (ZA); Gareth David Huntley Shaw, Hout Bay (ZA)

Correspondence Address: HAHN AND MOODLEY, LLP, P.O. BOX 52050, MINNEAPOLIS, MN, 55402, US

(21) Appl. No.: 11/569,271

(22) PCT Filed: May 15, 2005
(86) PCT No.: PCT/ZA05/00070

§ 371 Date: Mar. 26, 2007

Related U.S. Application Data
(60) Provisional application No. 60/573,551, filed on May 20, 2004.
(60) Provisional application No. 60/655,403, filed on Feb. 23, 2005.

(30) Foreign Application Priority Data
May 20, 2004 (ZA) 2004/3895
Feb. 23, 2005 (ZA) 2005/1588

(51) Int. Cl. C09K 5/04

(52) U.S. Cl. 62/114

(57) ABSTRACT

The invention provides a cooling method for a natural gas conversion complex. The method includes the steps of circulating sea water in a first, open, cooling circuit (12); contacting the sea water with a heat exchanger (14) to absorb heat; cooling the sea water from the outflow of the heat exchanger (14); circulating fresh water in a second, closed, cooling circuit (18); and contacting the fresh water with the heat exchanger (14) to lose heat.

### TECHNICAL FIELD OF THE INVENTION

This invention relates to a cooling method and plant for a natural gas conversion complex.

### BACKGROUND TO THE INVENTION

A typical natural gas conversion complex such as a Gas to Liquids (GTL) production complex of 220 tons per hour (t/h) has a total cooling water demand of about 2400 MW. Cooling water is needed primarily for condensation of steam in the condensers of steam turbines in the Air Separation Units (ASU) and power generating units. Further cooling water is needed for heat exchangers in the GTL process units. It is known that the cooling water demand for the ASU and power generating units can be satisfied by a once-through seawater cooling system. It is further known that the demand for heat exchangers in the process units can be met with a fresh water cooling system. For a typical GTL production complex the seawater cooling system would have a circulation flow of about 123 000 t/h with a temperature difference of 15° C. of the seawater between intake and discharge of the seawater. The fresh water cooling system would typically need a circulation flow of about 14 300 t/h with a temperature difference of 14° C. between the cold water supply and hot water return to a cooling tower. Losses of water from the system are compensated for by supplying wastewater after treatment in a wastewater treatment plant to the cooling tower. It will be appreciated that the return of heated sea water to the sea heats the sea with negative environmental impact. It is an object of this invention to provide a cost effective cooling method and plant, which has an improved environmental impact.

### GENERAL DESCRIPTION OF THE INVENTION

According to a first aspect of the invention there is provided a cooling method for a natural gas conversion complex, which method includes the steps of:

circulating sea water in a first, open, cooling circuit;

contacting the sea water with a heat exchanger to absorb heat;

cooling the sea water from the outflow of the heat exchanger;

circulating fresh water in a second, closed, cooling circuit; and

contacting the fresh water with the heat exchanger to lose heat.

The method may further include the step of condensing steam in the condensers of steam turbines with the cooled sea water.

The method may further include the step of exchanging heat with heat exchangers of the natural gas conversion complex with the cooled fresh water.

The method may further include the step of supplementing the sea water from a sea water intake unit.

The method may also include returning cooled sea water to the sea as blowdown.

According to a further aspect of the invention, there is provided cooling plant for a natural gas conversion complex, which plant includes:

a first, open, sea water cooling circuit;

a heat exchanger for heating the sea water;

a cooling means for cooling the sea water from the outflow of the heat exchanger;

a second, closed, fresh water cooling circuit in contact with the heat exchanger for exchanging heat with the cooled sea water.

The cooling means may be selected from a natural draft (hyperbolic) tower, forced draft cooling tower, counter flow induced tower, cross flow induced draft tower or variations thereof, depending on the cooling water demand of the natural gas conversion complex.

The cooling plant may include a blowdown means for returning cooled sea water to the sea.

The natural gas conversion complex may be a Catalytic Conversion of Olefins to Distillates (COD), Gas to Liquids (GTL), Fisher-Tropsch (FT) or methanol production complex or mixtures thereof.

### DETAILED DESCRIPTION OF THE INVENTION

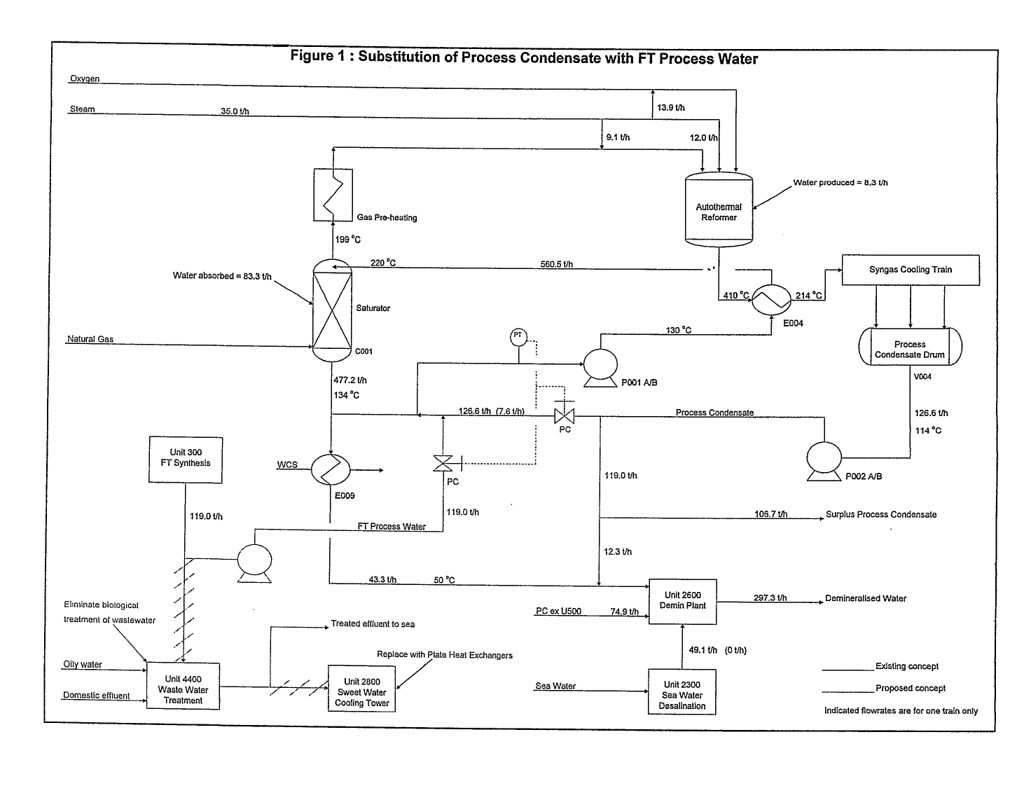

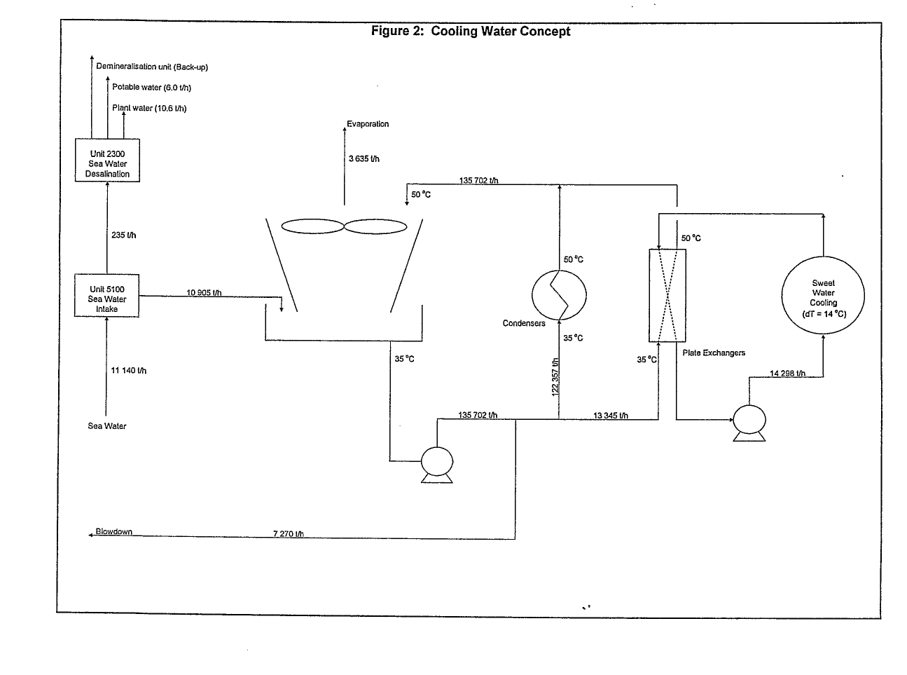

The invention is now described by way of a typical example of a 220 t/h GTL production complex with reference to the accompanying diagrammatic drawing, FIG. 1. FIG. 1 shows a flow diagram of a cooling method and plant for a natural gas conversion complex, in accordance with the invention.

Referring now to FIG. 1, the cooling plant for a natural gas conversion complex, in accordance with the invention is generally indicated by reference numeral 10, includes a first, open, sea water cooling circuit 12, a plate heat exchanger 14 for heating the sea water and a cooling means, in the form of an evaporative cooling tower 16, for cooling the sea water from the outflow of the heat exchanger 14. The cooling plant also includes a second, closed, fresh water cooling circuit 18 in contact with the plate heat exchanger 14 for exchanging heat with the cooled sea water. The cooling circuit 12 also includes steam condensers 20 of steam turbines in the air separation and power generating units.
About 135702 t/h sea water is circulated in the first, open, cooling circuit 12.
About 122357 t/h of the sea water is required primarily for condensation of steam in the condensers 20 of steam turbines in the air separation and power generating units. About 13345 t/h enters the plate heat exchangers 14 at 35° C. and exiting at 50° C. The fresh (sweet) water cooling circuit 18 circulates at 14298 t/h providing a temperature absorbing capacity of 14° C. (dT).
About 3635 t/h of the sea water evaporates in the cooling tower 16 and 7270 t/h of the cooled and concentrated 35° C. sea water is returned to the sea (blowdown). The returned sea water solution is concentrated by a factor of about 1.5, the cycle of concentration.

The evaporated and returned sea water is supplemented by a sea water intake unit 22 with 10905 t/h seawater. About 235 t/h of sea water is routed to a sea water desalination plant 24 for production of desalinated water for use elsewhere in the complex 10.

It will be appreciated that:

The required capacity and cost of the seawater intake unit will be reduced significantly, compared to a once through seawater system. The demand for seawater will reduce from the approximate prior art requirement of 122 357 t/h to about 11 140 t/h, a reduction of about 90 %;
The prior art design of an evaporative cooling tower with treated FT wastewater as make-up source, requires that spare capacity and storage facilities be provided in a desalination unit to ensure sufficient make-up of fresh water to the tower to compensate for upsets in the wastewater treatment plant and/or the FT synthesis unit. This is no longer required for the cooling method and plant, in accordance with the invention, as prior art cooling tower (evaporative) systems will be replaced by a plate heat exchanger cooling system (closed system). This allows a typical design capacity of the desalination unit for a 220 t/h GTL production complex to be reduced to 100 t/h;
It is estimated that the cooling water supply temperature from the seawater cooling tower, in accordance with the invention, can be reduced to 33° C. and lower depending on the environmental conditions. A temperature difference in excess of 15° C. is therefore possible, which will result in a reduction of the required condenser surface area and/or in the demand for cooling water;
A reduction in cooling water supply temperature to the condensers of the power generating units will result in the condensers being operated at a lower vacuum, which in turn will result in increased power generation and available power;
A temperature difference of more than 14° C. can be used in the design of the fresh water circuit due to the colder supply temperature of seawater to the heat exchangers. It will therefore be possible to reduce the investment cost required for heat exchangers,
Environmental legislation, such as in the Persian Gulf, requires that the discharge of effluent streams into a receiving water body will not result in:
   a temperature increase in excess of 3° C. at a radius of 100 m from the point of discharge, and
   the Total Dissolved Solids concentration (TDS) of the receiving water body may not be increased by more than 10% at a radius of 200 m from the point of discharge.
With the cooling method and plant, in accordance with the invention, hot water will no longer be returned to the ocean, as the blowdown from the seawater cooling tower will be taken from the cold water supply to the plant. The TDS concentration of the blowdown water from the tower will be about 50% higher than that of seawater if the tower is operated at cycles of concentration=1.5. However, this is not a problem due to the relatively low volumes compared to that returned to the ocean in terms of the prior art.

It shall be understood that the example is provided for illustrating the invention further and to assist a person skilled in the art with understanding the invention and are not meant to be construed as unduly limiting the reasonable scope of the invention.

1-9. (canceled)

10. A natural gas conversion complex water cooling method, which method includes the steps of:
circulating sea water in a first, open, cooling circuit;
contacting the sea water with a heat exchanger of a natural gas conversion complex to absorb heat;
cooling the sea water from the outflow of the heat exchanger;
circulating flesh water in a second, closed, cooling circuit of a natural gas conversion complex;
contacting the fresh water with the heat exchanger to lose heat and
condensing steam in the condensers of steam turbines with the cooled sea water.

11. A method as claimed in claim 10, which includes the step of supplementing the sea water from a sea water intake unit.

12. A method as claimed in claim 11, which method includes the step of returning cooled sea water to the sea.

13. A method as claimed in claim 12, which method includes the step of returning cooled sea water to the sea.

14. A natural gas conversion complex cooling plant, which plant includes:
a first, open, sea water cooling circuit;
a heat exchanger for heating the sea water;
a cooling means for cooling the seal water from the outflow of the heat exchanger;
a steam condenser of a steam turbine in the sea water cooling circuit after the cooling means; and
a second, closed, fresh water cooling circuit for a natural gas conversion complex in contact with the heat exchanger for exchanging heat with the cooled sea water.

15. A plant as claimed in claim 14, wherein the cooling means is selected from a group comprising a natural draft (hyperbolic) tower, forced draft cooling tower, counter flow induced tower, cross flow induced draft tower or variations thereof.
